(19) United States
(12) Patent Application Publication
(10) Pub. No.: US 2026/0298270 A1
(43) Pub. Date: Oct. 1, 2026

(54) METAL STRUCTURE

(71) Applicant: TUNG KANG STEEL STRUCTURE CORP., Taipei City (TW)

(72) Inventors: Yu-Chen LIANG, New Taipei City (TW); Huang-Chi FENG, Douliu City, Yunlin County (TW); Yu-Lung TSAO, Yunlin County (TW)

(21) Appl. No.: 19/335,073

(22) Filed: Sep. 22, 2025

Related U.S. Application Data
(60) Provisional application No. 63/781,440, filed on Apr. 1, 2025.

(51) Int. Cl. F16B 5/08

(52) U.S. Cl. CPC F16B 5/08

(57) ABSTRACT

A metal structure is provided. The metal structure includes a first metal member, a second metal member, and a weld material. The first metal member includes a first joint region, wherein the first joint region comprises a first joint surface and a first groove surface. The second metal member includes a second joint region, wherein the second joint region comprises a second joint surface and a second groove surface. The first joint surface and the second joint surface are joined to each other, a first included angle is defined between the first groove surface and the second groove surface, and the first included angle is greater than 0 degrees and less than 90 degrees. The weld material is filled between the first groove surface and the second groove surface, wherein the weld material joins the first groove surface and the second groove surface.

### CROSS REFERENCE TO RELATED APPLICATIONS

This application claims the benefit of U.S. Provisional Application No. 63/781,440, filed Apr. 1, 2025, the entirety of which is incorporated by reference herein.

### BACKGROUND OF THE INVENTION

### Field of the Invention

The present invention relates to a metal structure, and more particularly to a metal structure joined by welding.

### Description of the Related Art

In conventional column construction methods, when welding is performed at a structural corner with a single-sided groove on the web plate, the inherent material characteristics of the steel plate resulting from the rolling process, combined with the high heat input from arc welding, tend to cause concentrated thermal stress and shrinkage effects. These factors can easily lead to lamellar tearing in the flange region. This issue becomes particularly pronounced as the thickness of the steel plate increases, directly compromising the structural integrity and safety of the component.

Accordingly, when joining thick plates (generally referring to steel plates with a thickness greater than 40 mm) using conventional techniques, a double-sided groove is often employed to distribute the residual stress generated within the heat-affected zone during welding and to reduce the risk of tearing. However, the double-sided groove approach involves complex construction procedures, increased time and labor, and requires a large amount of filler metal, resulting in significantly higher material and labor costs, as well as reduced production efficiency.

On the other hand, in conventional steel structure production lines, thin plates (with a thickness of approximately 20 to 32 mm) and medium plates (with a thickness of approximately 32 to 40 mm) are typically still welded using a single-sided groove. While this method balances structural strength and construction efficiency, it not only increases operational complexity and cost (especially when thicker structural members necessitate a switch to double-sided grooves), but it may also disrupt standardized production processes, thereby affecting the overall workflow and scheduling flexibility of the production line.

### BRIEF SUMMARY OF THE INVENTION

In one embodiment, a metal structure is provided. The metal structure includes a first metal member, a second metal member, and a weld material. The first metal member includes a first joint region, wherein the first joint region comprises a first joint surface and a first groove surface. The second metal member includes a second joint region, wherein the second joint region comprises a second joint surface and a second groove surface. The first joint surface and the second joint surface are joined to each other, a first included angle is defined between the first groove surface and the second groove surface, and the first included angle is greater than 0 degrees and less than 90 degrees. The weld material is filled between the first groove surface and the second groove surface, wherein the weld material joins the first groove surface and the second groove surface.

In one embodiment, the metal structure further includes a support member, wherein the support member is connected to the first metal member and the second metal member, and the shape of the support member varies according to an included angle between the first metal member and the second metal member.

In one embodiment, the support member is made of a metallic material.

In one embodiment, the support member is connected to the first metal member and the second metal member by welding.

In one embodiment, the support member is made of clay or ceramic material.

In one embodiment, the first joint surface and the first groove surface are coplanar.

In one embodiment, the first joint surface and the second joint surface are joined by laser welding.

In one embodiment, the weld material joins the first groove surface and the second groove surface by arc welding.

In one embodiment, the support member is in the shape of a cube or a triangular prism.

In one embodiment, the area of the first joint surface is greater than the area of the first groove surface.

In one embodiment, the first included angle is between 30 degrees and 60 degrees.

In one embodiment, a normal line is perpendicular to the first joint surface, the second metal member extends along an extension line, a second included angle is defined between the extension line and the normal line, and the second included angle is between −45 degrees and 45 degrees.

In one embodiment, the metal structure is a box-type column or a non-standard shaped column.

The metal structure provided by the embodiments of the invention utilizes innovative welding techniques, which generates significantly less heat compared to conventional methods during the welding process. Furthermore, the adoption of a single-sided groove design significantly reduces the required amount of metal filler compared to conventional double-sided groove welding. Therefore, the resulting thermal shrinkage stress can be substantially reduced, which effectively suppresses defects such as lamellar tearing in the thickness direction of steel plates, thereby improving overall joint quality and structural safety.

Moreover, since the embodiment of the invention enables high-quality joining with relatively low heat input, production costs can be significantly reduced. The overall manufacturing efficiency can be improved by approximately 5 to 10 times compared to traditional methods, substantially shortening the construction cycle and offering high practical value.

It is worth noting that for T-joints (including corner joints) and similar component structures, the inherent design typically only allows single-sided groove welding, which is inherently challenging and significantly affected by the performance and setup of welding equipment. To address this challenge, the implementation of the embodiments of the invention allows for adjustment of the laser head angle, energy output, and focal parameters to optimize weld penetration depth and width, ensuring stable and consistent weld quality.

The metal structure provided by the embodiments of the invention not only effectively reduces the number of weld seams and the amount of weld material required for box-type column components, but also greatly enhances processing efficiency and productivity. The overall process also provides energy-saving benefits. This technology helps reduce the cost of steel structure manufacturing and aligns with the current industry trend toward low carbon emissions and sustainable development.

### BRIEF DESCRIPTION OF THE DRAWINGS

The present invention can be more fully understood by reading the subsequent detailed description and examples with references made to the accompanying drawings, wherein:

FIG. 1 shows a metal structure according to a first embodiment of the invention;

FIG. 2 shows a box-type column according to the first embodiment of the invention;

FIG. 3A shows a metal structure according to a second embodiment of the invention;

FIG. 3B shows a box-type column according to the second embodiment of the invention; and

FIG. 4 shows a metal structure according to a third embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

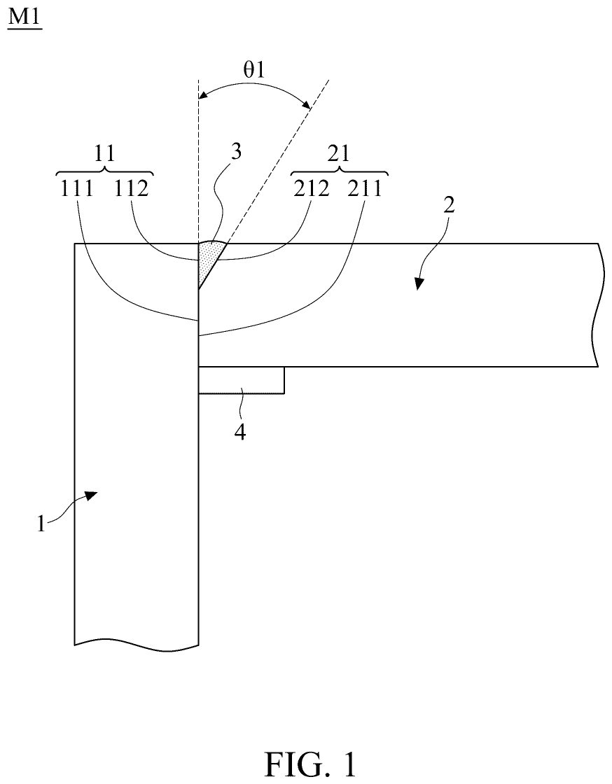

FIG. 1 shows a metal structure according to a first embodiment of the invention. With reference to FIG. 1, a metal structure M1 of the embodiment of the invention includes a first metal member 1, a second metal member 2, and a weld material 3. The first metal member 1 includes a first joint region 11, wherein the first joint region 11 includes a first joint surface 111 and a first groove surface 112. The second metal member 2 includes a second joint region 21, wherein the second joint region 21 includes a second joint surface 211 and a second groove surface 212. A first included angle θ1 is defined between the first groove surface and the second groove surface, and the first included angle θ1 is greater than 0 degrees and less than 90 degrees. In another embodiment, the first included angle θ1 is between 30 degrees and 60 degrees. The second joint surface 211 is joined to the first joint surface 111. The weld material 3 is filled between the first groove surface 112 and the second groove surface 212, wherein the weld material 3 joins the first groove surface 112 and the second groove surface 212.

With reference to FIG. 1, in one embodiment, the metal structure M1 further includes a support member 4. The support member 4 is connected to the first metal member 1 and the second metal member 2, so as to support the second metal member 2 and to prevent molten metal from overflowing during the welding process. The shape of the support member 4 may vary according to the included angle between the first and second metal members to provide optimal support. In one embodiment, the support member 4 is a cube. In addition to providing support, the support member 4 also helps prevent stress concentration.

With reference to FIG. 1, in one embodiment, the first joint surface 111 and the first groove surface 112 are coplanar. In one embodiment, the term “coplanar” refers to the condition in which the first joint surface 111 is in an unmelted state prior to laser welding.

With reference to FIG. 1, in one embodiment, the first joint surface 111 and the second joint surface 211 are joined by laser welding. In other words, the first joint surface 111 is first brought into direct contact with the second joint surface 211. Then, a laser is applied to the first joint surface 111 and the second joint surface 211, thereby melting the metal material of the joint surfaces (the first joint surface 111 and the second joint surface 211) and causing them to fuse together.

With reference to FIG. 1, in one embodiment, the weld material 3 is filled between the first groove surface 112 and the second groove surface 212 and is melted by arc welding to join the first groove surface 112 and the second groove surface 212. In another embodiment, part of the weld material 3 may also enter the space between the first joint surface 111 and the second joint surface 211 during the welding process.

With reference to FIG. 1, in one embodiment, the support member 4 is connected to the first metal member 1 and the second metal member 2 by welding. In one embodiment, the support member 4 is made of a metallic material. In another embodiment, the support member 4 may be made of clay or ceramic material. The disclosure is not meant to restrict the invention.

With reference to FIG. 1, in one embodiment, the area of the first joint surface 111 is greater than the area of the first groove surface 112.

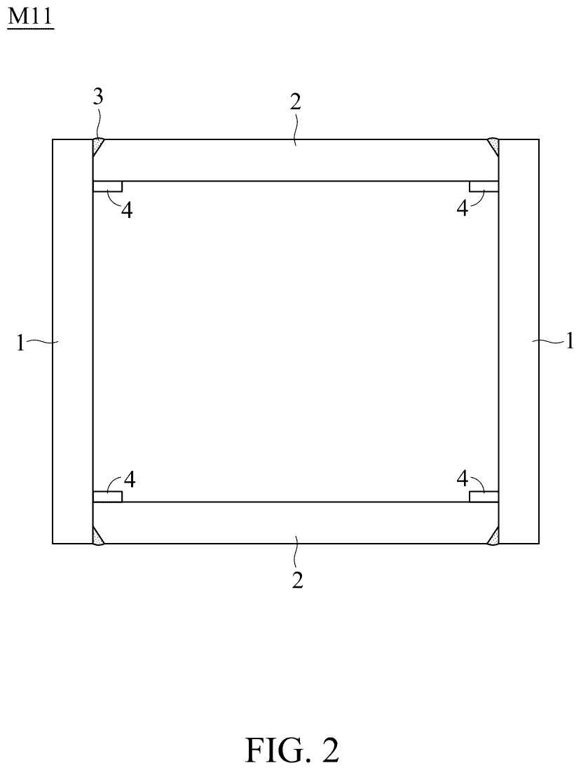

FIG. 2 shows a box-type column according to the first embodiment of the invention. With reference to FIG. 2, in one embodiment, the metal structure may be a box-type column M11. The box-type column M11 includes two first metal members 1 and two second metal members 2. In one embodiment, the first metal members 1 serve as flange plates and the second metal members 2 serve as web plates. In one embodiment, the first metal members 1 and the second metal members 2 are medium-thick plates (thickness greater than 20 mm).

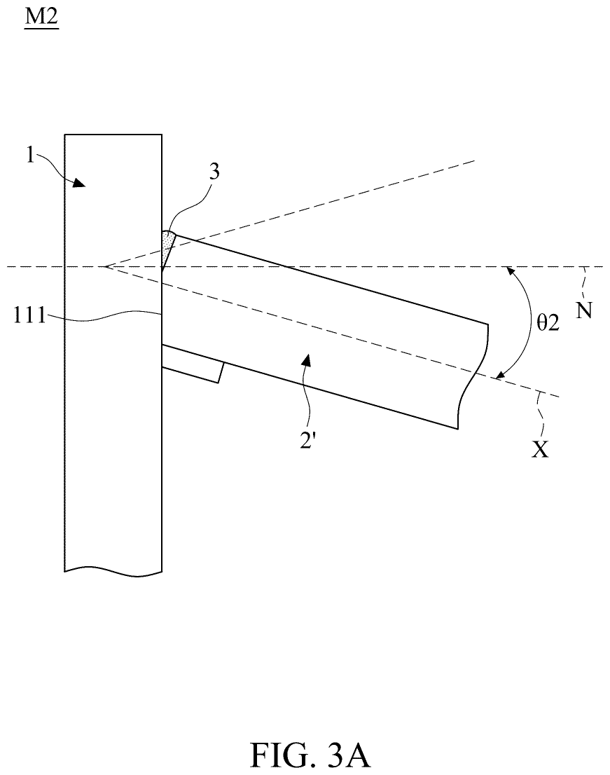

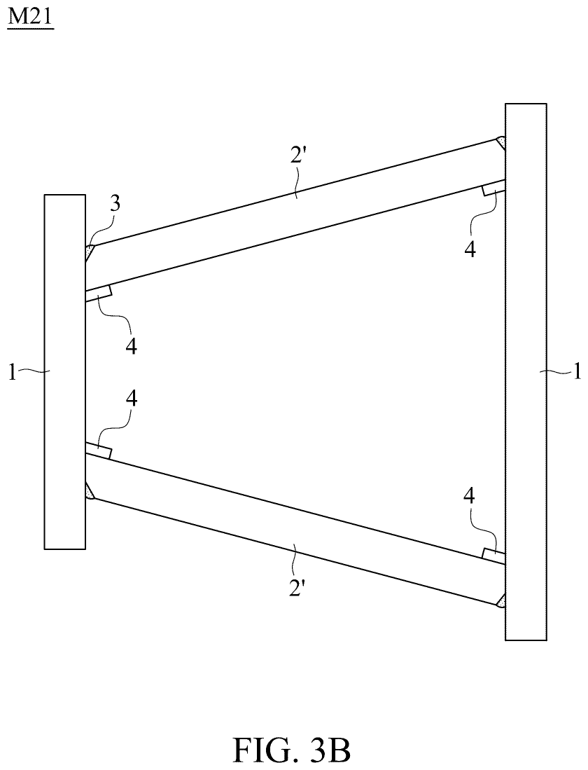

FIG. 3A shows a metal structure according to a second embodiment of the invention. With reference to FIG. 3A, the metal structure M2 includes a first metal member 1, a second metal member 2′ and a weld material 3. In one embodiment, the first metal member 1 and the second metal member 2′ are steel plates. A normal line N is perpendicular to the first joint surface 111, and the second metal member 2′ extends along an extension line X. A second included angle θ2 is defined between the extension line X and the normal line N. The second included angle θ2 is between −45 degrees and 45 degrees. In this embodiment, the second metal member 2′ is joined to the first metal member 1 in an inclined orientation.

FIG. 3B shows a box-type column according to the second embodiment of the invention. With reference to FIG. 3B, in one embodiment, the metal structure may be a box-type column M21. The box-type column M21 includes two first metal members 1 and two second metal members 2′. At least one of the second metal members 2′ is joined to the first metal member 1 in an inclined orientation.

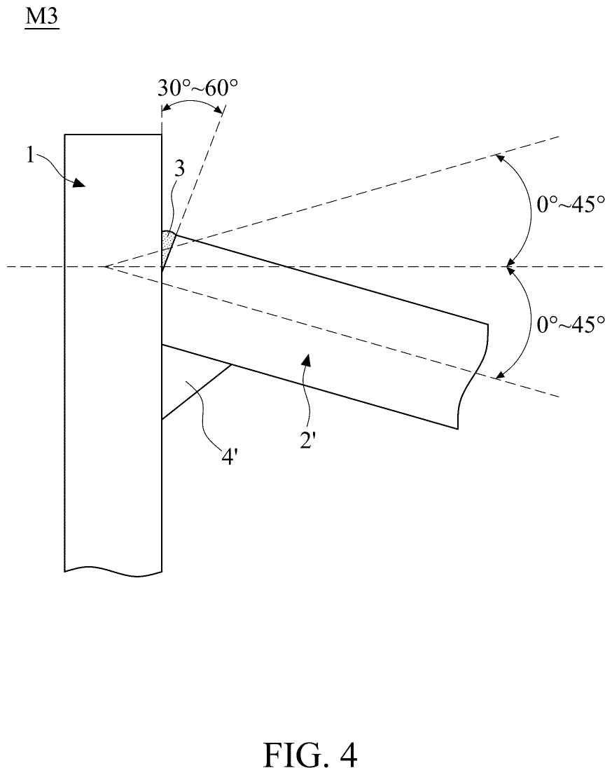

FIG. 4 shows a metal structure according to a third embodiment of the invention. With reference to FIG. 4, in the metal structure M3, the support member 4′ is a triangular prism.

The metal structure provided by the embodiments of the invention utilizes innovative welding techniques, which generates significantly less heat compared to conventional methods during the welding process. Furthermore, the adoption of a single-sided groove design significantly reduces the required amount of metal filler compared to conventional double-sided groove welding. Therefore, the resulting thermal shrinkage stress can be substantially reduced, which effectively suppresses defects such as lamellar tearing in the thickness direction of steel plates, thereby improving overall joint quality and structural safety.

Moreover, since the embodiment of the invention enables high-quality joining with relatively low heat input, production costs can be significantly reduced. The overall manufacturing efficiency can be improved by approximately 5 to 10 times compared to traditional methods, substantially shortening the construction cycle and offering high practical value.

It is worth noting that for T-joints (including corner joints) and similar component structures, the inherent design typically only allows single-sided groove welding, which is inherently challenging and significantly affected by the performance and setup of welding equipment. To address this challenge, the implementation of the embodiments of the invention allows for adjustment of the laser head angle, energy output, and focal parameters to optimize weld penetration depth and width, ensuring stable and consistent weld quality.

The metal structure provided by the embodiments of the invention not only effectively reduces the number of weld seams and the amount of weld material required for box-type column components, but also greatly enhances processing efficiency and productivity. The overall process also provides energy-saving benefits. This technology helps reduce the cost of steel structure manufacturing and aligns with the current industry trend toward low carbon emissions and sustainable development.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A metal structure, comprising:
a first metal member, comprising a first joint region, wherein the first joint region comprises a first joint surface and a first groove surface;
a second metal member, comprising a second joint region, wherein the second joint region comprises a second joint surface and a second groove surface, the first joint surface and the second joint surface are joined to each other, a first included angle is defined between the first groove surface and the second groove surface, and the first included angle is greater than 0 degrees and less than 90 degrees; and
a weld material, filled between the first groove surface and the second groove surface, wherein the weld material joins the first groove surface and the second groove surface.

2. The metal structure as claimed in claim 1, further comprising a support member, wherein the support member is connected to the first metal member and the second metal member, and a shape of the support member varies according to an included angle between the first metal member and the second metal member.

3. The metal structure as claimed in claim 2, wherein the support member is made of a metallic material.

4. The metal structure as claimed in claim 3, wherein the support member is connected to the first metal member and the second metal member by welding.

5. The metal structure as claimed in claim 2, wherein the support member is made of clay or ceramic material.

6. The metal structure as claimed in claim 2, wherein the first joint surface and the first groove surface are coplanar.

7. The metal structure as claimed in claim 2, wherein the first joint surface and the second joint surface are joined by laser welding.

8. The metal structure as claimed in claim 2, wherein the weld material joins the first groove surface and the second groove surface by arc welding.

9. The metal structure as claimed in claim 2, wherein the support member is in the shape of a cube or a triangular prism.

10. The metal structure as claimed in claim 2, wherein an area of the first joint surface is greater than an area of the first groove surface.

11. The metal structure as claimed in claim 2, wherein the first included angle is between 30 degrees and 60 degrees.

12. The metal structure as claimed in claim 2, wherein a normal line is perpendicular to the first joint surface, the second metal member extends along an extension line, a second included angle is defined between the extension line and the normal line, and the second included angle is between −45 degrees and 45 degrees.

13. The metal structure as claimed in claim 1, wherein the metal structure is a box-type column or a non-standard shaped column.

14. The metal structure as claimed in claim 2, wherein the metal structure is a box-type column or a non-standard shaped column.

15. The metal structure as claimed in claim 3, wherein the metal structure is a box-type column or a non-standard shaped column.

16. The metal structure as claimed in claim 4, wherein the metal structure is a box-type column or a non-standard shaped column.

17. The metal structure as claimed in claim 5, wherein the metal structure is a box-type column or a non-standard shaped column.

18. The metal structure as claimed in claim 6, wherein the metal structure is a box-type column or a non-standard shaped column.

19. The metal structure as claimed in claim 7, wherein the metal structure is a box-type column or a non-standard shaped column.

20. The metal structure as claimed in claim 8, wherein the metal structure is a box-type column or a non-standard shaped column.
